(19) United States
(12) Patent Application Publication
(10) Pub. No.: US 2010/0180713 A1
(43) Pub. Date: Jul. 22, 2010

(54) Expanding and retracting structure for a control shaft of a bicycle

(76) Inventor: Wei-Chen Tseng, Fongyuan City (TW)

Correspondence Address: TSENG, WEI-CHEN, P.O. Box 697, Fongyuan City, 420, TW

(21) Appl. No.: 12/320,150

(22) Filed: Jan. 21, 2009

(51) Int. Cl. B62K 21/16

(52) U.S. Cl. 74/493

(57) ABSTRACT

An expanding and retracting structure for a control shaft of a bicycle mounted on a cylinder member includes a positioning member, and an engaging member, the positioning member and the engaging member being disposed on a top end of the cylinder member, the engaging member being a locking loop to be quickly retracted or expanded its inner diameter and to move the positioning member, in the cylinder member being fixed a bolt element; a screw screwed in the bolt element and having a tab mounted on a top portion thereof; a shaft member pivotally connecting with the screw, and the screw and the shaft member being insert into the cylinder member, the shaft member including a positioning slot to insert the positioning member, at a predetermined position of the shaft member being connected a connecting tube.

### BACKGROUND OF THE INVENTION

1. Field of the Invention

The present invention relates to an expanding and retracting structure for a control shaft of a bicycle that can quickly and easily adjust a handle to a desired height to accommodate different users' heights.

2. Description of the Prior Art

Conventional bicycle can not be used to adjust its handle according to user's heights, accordingly the fixed height of a handle will make user feel uncomfortable after riding the bicycle for a long period of time.

Conventional foldable bicycle can be removed into many parts, and the handle can be adjusted according to user's height, but the adjusting process is quite tedious.

For most bicycles, even though they are made in various sizes, before riding, a rider has to adjust a headset with handles to a suitable height and then position the headset. Unfortunately, after a long period of riding time, he will feel tired and painful due to keep the same riding posture all the time, especially for his waist, shoulder, neck, and wrist. What is worse, as on steep road or downgrade, the headset can not be adjusted to lower or raise its height immediately according to actual road condition.

The present invention has arisen to mitigate and/or obviate the afore-described disadvantages.

### SUMMARY OF THE INVENTION

The primary object of the present invention is to provide an expanding and retracting structure for a control shaft of a bicycle which can quickly and easily adjust a handle to a desired height to accommodate different users' heights.

Another object of the present invention is to provide an expanding and retracting structure for a control shaft of a bicycle which can adjust the height of the handle during riding without stop, obtaining riding safety.

To achieve the above object, an expanding and retracting structure for a control shaft of a bicycle provided by the present invention comprises: a positioning member, and an engaging member, the positioning member and the engaging member being disposed on a top end of the cylinder member, the engaging member being a locking loop to be quickly retracted or expanded its inner diameter and to move the positioning member, in the cylinder member being fixed a bolt element; a screw screwed in the bolt element and having a tab mounted on a top portion thereof; a shaft member pivotally connecting with the screw, and the screw and the shaft member being insert into the cylinder member, the shaft member including a positioning slot to insert the positioning member, at a predetermined position of the shaft member being connected a connecting tube.

### BRIEF DESCRIPTION OF THE DRAWINGS

FIG. 1 is a perspective view illustrating the exploded components of an expanding and retracting structure for a control shaft of a bicycle in accordance with the present invention;

FIG. 2 is a cross sectional view illustrating a handle being adjusted to move upward in accordance with the present invention;

FIG. 3 is a cross sectional view illustrating an engaging member activates a positioning member to engage a shaft member in accordance with the present invention;

FIG. 4 is a cross sectional view illustrating the handle being adjusted to move downward in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

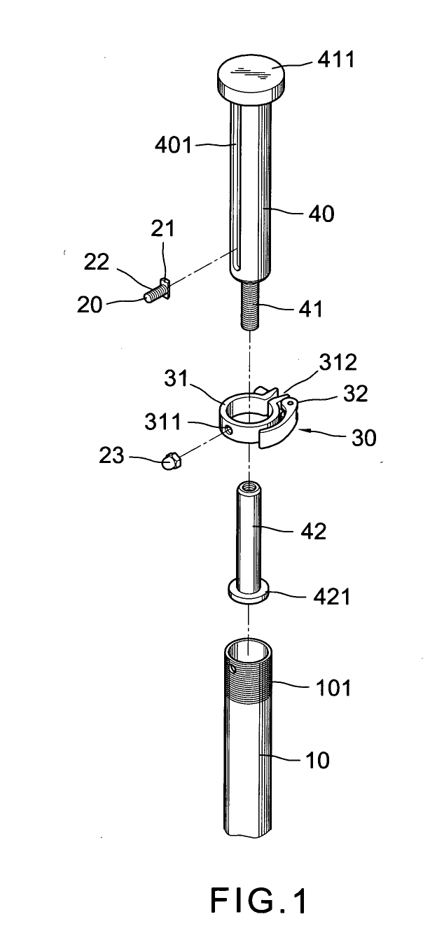

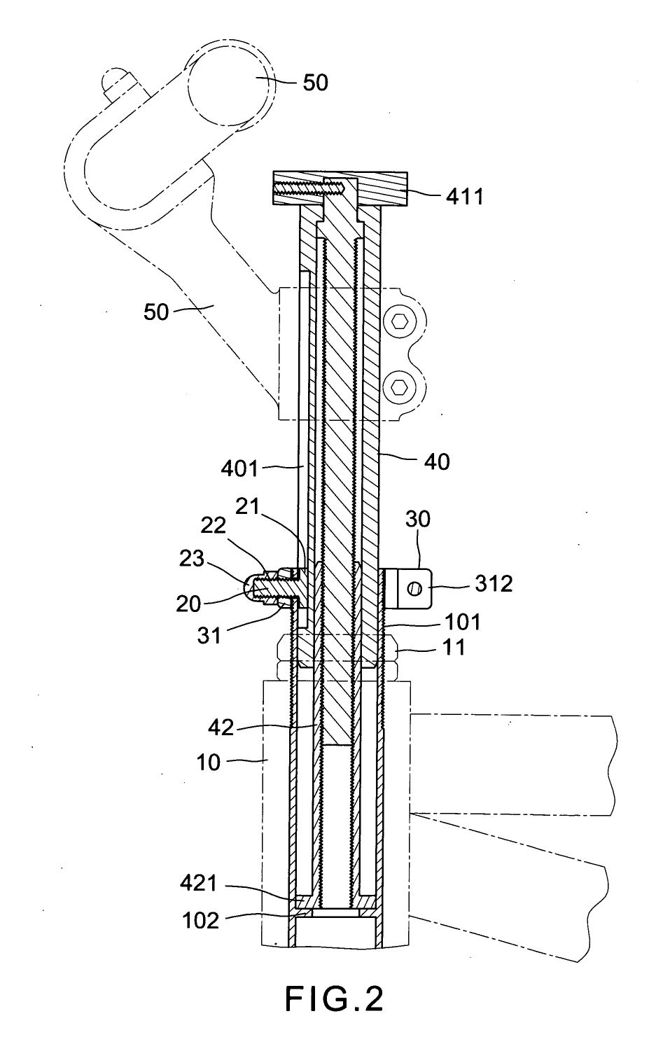

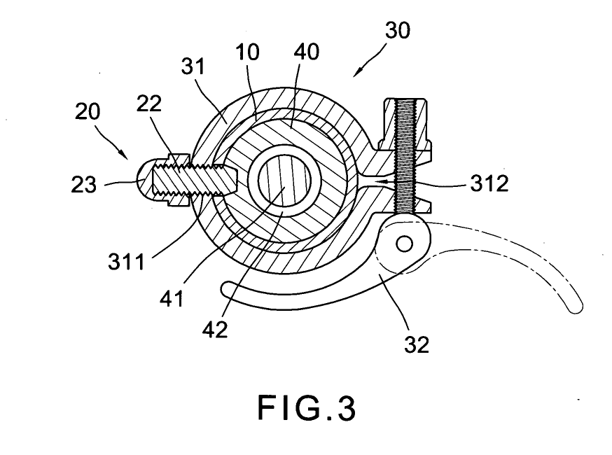

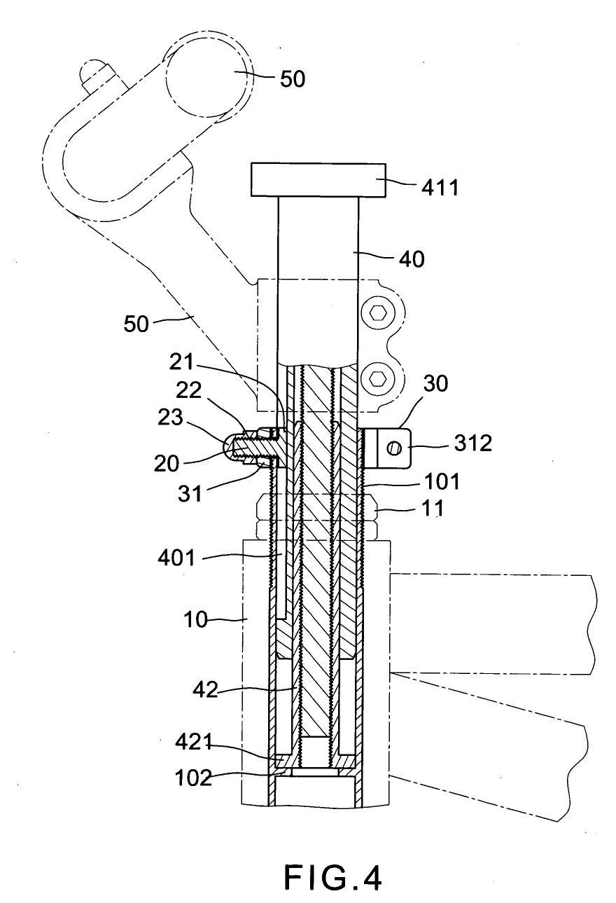

Referring to FIGS. 1-4, an expanding and retracting structure for a control shaft of a bicycle in accordance with the present invention comprises: a cylinder member 10, a positioning member 20, an engaging member 30, a shaft member 40, a screw 41, and a bolt element 42. The cylinder member 10 is disposed on an upper end of a front fork of the bicycle to freely rotate at a front end of a rack of the bicycle, on an upper end of the cylinder member 10 is formed threads 101 to screw with a plurality of stop rings 11 (as illustrated in FIG. 2), each of the stop rings 11 includes inner threads, and the engaging member 30 can be quickly retained and is comprised of a locking loop 31 and an eccentric lever 32. The locking loop 31 includes an opening 312 which is axially connected with the eccentric lever 32, the eccentric lever 32 is provided to lever to retract or expand an inner diameter of the locking loop 31. At a radial direction of the locking loop 31 is mounted a screw hole 311 to insert the positioning member 20, on an end of the positioning member 20 is fixed a retaining piece 21, and on another end thereof is arranged threads 22 to screw with a nut 23. With the retraction of the engaging member 30, the positioning member 20 can be engaged in the shaft member 40.

The shaft member 40 is inserted into the cylinder member 10 and includes a positioning slot 401 axially formed thereon, the positioning slot 401 is a dovetail slot, and the retaining piece 21 of the positioning member 20 is secured in the positioning slot 401. The retaining piece 21 is formed in the shape of a trapezium, at a predetermined position of the shaft member 40 is coupled a connecting tube 50 (as shown in FIG. 2), and the connecting tube 50 connects with a handle 51, the screw 41 is fitted in the shaft member 40 and a bolt element 42, and the screw 41 pivotally connects with the shaft member 40. On a top portion of the screw 41 is disposed an annular tab 411, the bolt member 42 is inserted in the cylinder member 10 and the shaft member 40, and on a bottom end of the bolt element 42 is mounted a disk-shaped projection 421. An outer diameter of the disk-shaped projection 421 is less than an inner diameter of the cylinder member 10, and the disk-shaped projection 421 is fixed in an external ring 102 of the cylinder member 10.

In operation, the eccentric lever 32 is rotated outward to expand the inner diameter of the locking loop 31, and after the expansion of the locking loop 31, the positioning member 20 moves outward with the locking loop 31 to disengage from the positioning slot 401 of the shaft member 40. The retaining piece 21 of the positioning member 20 can freely displace in the positioning slot 401 of the shaft member 40 to rotate the annular tab 411, thus the screw 41 is rotated with the annular tab 411. By using outer threads of the screw 41 and inner threads of the bolt element 42, the screw 41 rotates upward or downward, and because the screw 41 axially couples with the shaft member 40, the screw 41 activates the shaft member 40 to move upward or downward so that the shaft member 40 (or the handle 51) displaces upward and downward to adjust its height.

As desiring to position, the eccentric lever 32 is levered back to its original position, and the inner diameter of the locking loop 31 become retractable, and the positioning member 20 retracts inward slightly to engage the positioning slot 401 securely. The retaining piece 21 of the positioning member 20 engages the positioning slot 401 of the shaft member 40 so that the shaft member 40 can not displace upward and downward freely, thereby the shaft member 40 is positioned.

The bolt element 42 can be used to match various sizes of the bicycles, and the disk-shaped projection 421 of the bolt element 42 allows to keep the bolt element 42 in a central position to enhance the stability of the shaft member 40 as the shaft member 40 retracts.

By screwing the screw 41 with the bolt element 42 to support a downward force of the handle 51, the shaft member 40 is positioned. The retaining piece 21 of the positioning member 20 can be used to control the expansion and retraction of the shaft member 40. Therefore, even though the eccentric lever 32 is suddenly levered outward, the shaft member 40 and the handle 51 can not be moved downward or disengaged, keeping riding safety.

Besides, the handle 51 can be adjusted to a desired height to accommodate different users' heights, and it can also be adjusted to a suitable height during riding. The eccentric lever 32 is provided to quickly retract or expand the locking loop 31.

While we have shown and described various embodiments in accordance with the present invention, it is clear to those skilled in the art that further embodiments may be made without departing from the scope of the present invention.

What is claimed is:

1. An expanding and retracting structure for a control shaft of a bicycle mounted on a cylinder member comprising:
a positioning member, and an engaging member, the positioning member and the engaging member being disposed on a top end of the cylinder member, the engaging member being a locking loop to be quickly retracted or expanded its inner diameter and to move the positioning member, in the cylinder member being fixed a bolt element;
a screw screwed in the bolt element and having a tab mounted on a top portion thereof;
a shaft member pivotally connecting with the screw, and the screw and the shaft member being insert into the cylinder member, the shaft member including a positioning slot to insert the positioning member, at a predetermined position of the shaft member being connected a connecting tube.

2. The expanding and retracting structure for the control shaft of the bicycle as claimed in claim 1, wherein the shaft member includes the positioning slot axially formed thereon, on an end of the positioning member is fixed a retaining piece, and on another end thereof is arranged threads to screw with a nut.

3. The expanding and retracting structure for the control shaft of the bicycle as claimed in claim 1, wherein the locking loop includes an opening which is axially connected with the eccentric lever, the eccentric lever is provided to retract or expand an inner diameter of the locking loop.

4. The expanding and retracting structure for the control shaft of the bicycle as claimed in claim 1, wherein at a radial direction of the locking loop is mounted a screw hole to insert the positioning member.

5. The expanding and retracting structure for the control shaft of the bicycle as claimed in claim 1, wherein on a bottom end of the bolt element is mounted a disk-shaped projection, the disk-shaped projection is fixed in an external ring of the cylinder member.
